(19) United States
(12) Patent Application Publication
(10) Pub. No.: US 2023/0086101 A1
(43) Pub. Date: Mar. 23, 2023

(54) ASSESSING RISK OF FUTURE UNCORRECTABLE MEMORY ERRORS WITH FULLY CORRECTABLE PATTERNS OF ERROR CORRECTION CODE

(71) Applicant: Intel Corporation, Santa Clara, CA (US)

(72) Inventors: Cong Li, Shanghai (CN); Kuljit Bains, Olympia, WA (US); Shen Zhou, Shanghai (CN)

(21) Appl. No.: 18/057,476

(22) Filed: Nov. 21, 2022

(30) Foreign Application Priority Data
Nov. 4, 2022 (CN) PCT/CN2022/130011

(51) Int. Cl. G06F 11/10; G06F 3/06

(52) U.S. Cl. CPC G06F 11/1044; G06F 3/0616; G06F 3/0653; G06F 3/0673

(57) ABSTRACT

Systems, apparatuses and methods may provide for technology that identifies a plurality of fully correctable patterns associated with an error correction code (ECC) in a memory controller, detects one or more correctable errors in a memory module coupled to the memory controller, and generates an alert if an error-bit pattern of the one or more correctable errors does not match one or more of the plurality of fully correctable patterns.

### CROSS-REFERENCE TO RELATED APPLICATIONS

This patent application claims the benefit of priority to International Patent Application No. PCT/CN2022/130011, filed on Nov. 4, 2022.

### TECHNICAL FIELD

Embodiments generally relate to correcting memory errors. More particularly, embodiments relate to assessing the risk of future uncorrectable memory errors with fully correctable patterns of error correction code (ECC).

### BACKGROUND

A computing system typically includes a memory controller coupled to a set of dual inline memory modules (DIMMs, e.g., system memory including one or more dynamic random access memory/DRAM chips), wherein the memory controller implements memory system level error correction code (ECC) to correct errors in bits residing on the DIMM. In such a case, the memory controller may determine how to use those bits as data bits, ECC metadata bits, or bits for other purposes. While historically, a CHIPKILL ECC may have been able to correct any number of erroneous bits from a single DRAM chip in a cache line access, more recently the ECC on modern platforms gets weakened (e.g., one or more ECC bits are reallocated to non-error detection operations). Accordingly, certain combinations of erroneous bits from a single chip may not be correctable based on the ECC design. Assessing the risk of future uncorrectable error (UE) occurrence therefore becomes more subtle due to the complexity of the weakened ECC.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of fully correctable error-bit patterns and actual error-bit patterns according to an embodiment;

FIG. 2 is a block diagram of an example of a logical architecture according to an embodiment;

FIG. 3 is a chart of an example of precision and recall in uncorrectable error (UE) prediction according to an embodiment;

FIG. 4 is a chart of an example of precision and recall in UE prediction according to another embodiment;

FIG. 5 is a flowchart of an example of a method of operating a performance-enhanced memory controller according to an embodiment;

FIG. 6 is a block diagram of an example of a computing system according to an embodiment; and

FIG. 7 is an illustration of an example of a semiconductor package apparatus according to an embodiment.

### DESCRIPTION OF EMBODIMENTS

A commonly-used indicator for assessing the risk of future uncorrectable error (UE) occurrences is a correctable error (CE) rate indicator, which may count the number of CEs in a predefined time period (e.g., 24 hours) and compare the number of CEs to a predefined threshold. Conventional CEs, however, are observations only and the underlying causes are faulty micro-level DRAM components. The CE rate indicator does not consider the underlying faults and how those faulty components will manifest in UEs due to the error correction capability of the specific ECC implementation.

More advanced approaches may examine the error locations in certain micro-level DRAM components such as rows, columns, banks, etc., to infer whether there are certain faulty components and correlate the inferred fault with a potential future UE through empirical analysis (e.g., machine learning). While these approaches may capture certain characteristics of the faults in micro-level DRAM components, in many cases the disconnection from the faults to the coverage of the ECC makes the approaches ECC-agnostic. In those cases, the approaches fail to detect UE-prone faults (e.g., fail to identify the strong correlation between future UEs and those UE-prone faults).

Accordingly, none of the conventional approaches consider the specific implementation or knowledge of the ECC coverage implemented in the integrated memory controller (IMC). Without the most critical piece of information in such assessments, the assessment result is not reliable in many cases.

Technology described herein addresses the problem of using an existing history of correctable errors (CEs) of a dual in-line memory module (DIMM) to assess the risk of encountering uncorrectable errors (UEs) in the future. More particularly, embodiments provide an enhanced approach to assess the risk of future UEs according to platform specific ECC knowledge and real time CE history. Here, the ECC refers to the memory system level ECC, which is implemented in the memory controller, but not in the DIMMs. While all the bits reside in the DIMMs, the memory controller determines whether to use those bits as data bits, ECC metadata bits, or bits for other purposes.

For a certain implementation of a weakened ECC in modern platforms, several coarse-grained fully correctable patterns are well defined. If erroneous bits from a single DRAM chip in a cache line access can be covered by one of the patterns, the error is guaranteed to be correctable. If a CE cannot be covered with any of those fully correctable patterns, the CE is regarded as a “risky” CE in terms of ECC-guaranteed coverage (e.g., even though the error is correctable). Embodiments define the risky CE indicator for a DIMM, wherein the indicator is activated given a risky CE being observed historically. The risky CE indicator is much more informative in correlating with future UEs than the traditional CE rate indicator. Combined with the micro-level DRAM fault identification, the risky CE indicator can be used to improve performance in UE prediction.

The well-defined coarse-grained fully correctable patterns provide the adequate ambiguity to identify some correctable but risky errors. Due to the non-deterministic memory content and access, the uncertainty of the errors caused by the same UE-prone fault then plays a role in correlating those risky CEs with a potential UE in the future. It becomes much easier to identify such a strong correlation through empirical analysis. UE predictors with a much higher performance can then be built.

Low-cost RAS (Reliability, Availability, Serviceability) solutions for 5×8 and 9×4 DDR5 (Double Data Rate 5) as an example do not have full device coverage. Such configurations will benefit substantially from the technology described herein. As a result, overall coverage will approach the coverage of an SDDC (Single Device Data Correction) system. Indeed, 10×4 DDR5 systems will also benefit if the systems do not have perfect SDDC as some ECC bits are repurposed for metadata.

The technology described herein improves server platform reliability by adding a novel telemetry for highly effective future UE assessment, which allows original equipment manufacturers (OEMs) and/or cloud service providers (CSPs) to build a more reliable system with the effective mitigation of the risk of fatal memory failures on-the-fly. The technology described herein also creates a unique RAS capability differentiation.

While in the past the traditional CHIPKILL ECC may tolerate any failures from a single chip, the ECC on modern platforms may be weakened. For example, certain ECC metadata bits previously used by the ECC are reallocated for other uses (e.g., not for error detection and correction). Accordingly, the number of the remaining ECC metadata bits is less than enough to tolerate all possible failures from a chip. Following the ECC design, there are some predefined error-bit patterns. If the erroneous data bits in a memory access from a single chip are covered by one of the patterns, those erroneous bits are guaranteed to be correctable.

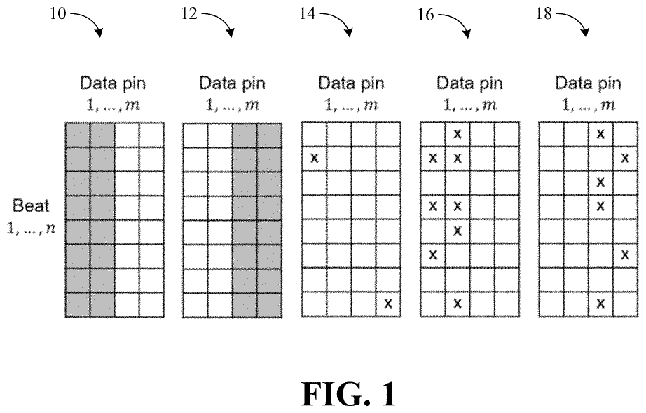

FIG. 1 demonstrates that from the perspective of the ECC procedure, a chip in a DIMM provides n×m bits of data during a memory access. The data bits are assumed to be served through n beats over m data pins regardless of the actual bit storage architecture implemented by the DIMM manufacturer. For a standard DDR4×4 DIMM, n=8 and m=4. For an 8×8 DIMM, the ECC regards a physical chip as two logical chips, each serving 32 bits. The n×m bits may therefore be visualized in a bitmap, as is shown in FIG. 1.

More particularly, a first fully correctable pattern 10 and a second fully correctable pattern 12 demonstrate that in a certain ECC implementation, if all the actual erroneous bits of an error are bounded within the left or right half, respectively, of the bitmap (e.g., the first or last m/2 data pins over the n beats), the error is guaranteed to be correctable.

If the actual error-bit pattern of a CE cannot match with any fully correctable patterns 10, 12, the CE becomes risky in terms of ECC guaranteed coverage despite the fact that the error is actually corrected by the ECC. Assuming that the fully correctable patterns 10, 12 are the only two fully correctable patterns 10, 12 available, an actual error-bit pattern 14 may correspond to a risky CE. By contrast, an actual error-bit pattern 16 and an actual error-bit pattern 18 correspond to two CEs that are not risky.

Embodiments may also define a Boolean indicator termed a “risky CE occurrence”. Given a CE observed on a DIMM, when the actual error-bit pattern of the CE cannot match with any of the fully correctable patterns 10, 12, the indicator is activated.

While the coarse-grained ECC knowledge is used, that is, the fully correctable patterns 10, 12, knowing the exact correctable and uncorrectable error-bit patterns may not help. In that case, any CE can match with one of the fully correctable patterns 10, 12, but no CEs can match with any uncorrectable patterns, resulting in trivial information only. Those coarse-grained fully correctable patterns 10, 12 used by the technology described herein provide the adequate ambiguity to identify some correctable but risky errors. The uncertainty of the errors caused by the same fault then plays a role in correlating those CEs with a potential UE in the future.

The risky CE indicator can be optionally enhanced by accumulating the historical erroneous bits in CEs of a location over time. For example, if on the same DIMM address a CE with the error bits shown in the actual error-bit pattern 16 occurs first and another with the error bits in the actual error-bit pattern 18 occurs later, accumulating the erroneous bits in the two CEs will show that the underlying fault may fall out of the coverage of the fully correctable patterns 10, 12. The risky CE indicator may then be activated. Most likely, such an enhancement enables the opportunity to activate the indicator before a risky CE occurs. Nonetheless, given a decent probability that an error is still a CE even if the erroneous bits cannot match with any fully correctable pattern 10, 12, it is likely that a risky CE will occur before the UE occurrence. Meanwhile, this approach is at the cost of tracking the historical erroneous bits for all addresses with CEs.

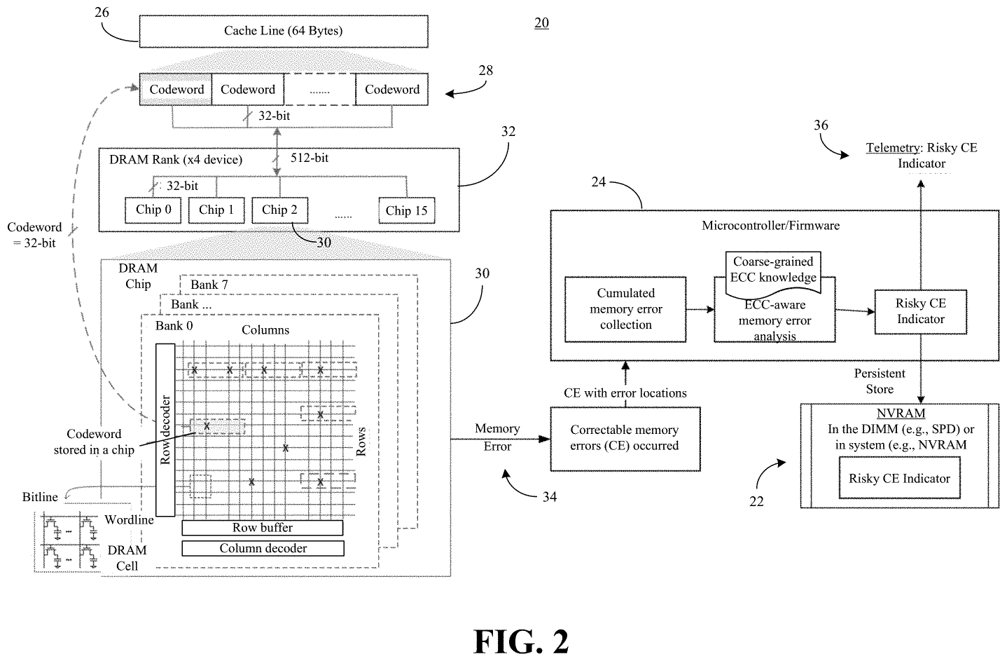

FIG. 2 shows a logical architecture 20 in which silicon provides the ability to monitor micro-level memory error information 34 with bit-level error locations, as well as system configuration. In general, a cache line 26 includes a plurality of codewords 28, with each codeword 28 coming from a respective chip 30 in a DRAM rank 32 of a memory module (e.g., DIMM). Additionally, the memory module provides an accessible persistent storage infrastructure 22 such as a Serial Presence Detect (SPD) table or other non-volatile media. In the illustrated example, a memory controller 24 (e.g., microcontroller and/or firmware) monitors CEs and decodes the corresponding micro-level error bit information by using the capability to monitor micro-level memory error information with bit-level error locations. The memory controller 24 also calculates and updates micro-level error statistics for the memory module when a CE occurs. In an embodiment, the memory controller 24 detects DIMM level risky CE indicator according to cumulated memory error history and coarse-grained ECC knowledge. Moreover, the memory controller 24 exposes the risky CE indicator as platform telemetry 36 and/or persistently stores the risky CE indicator in the persistent storage infrastructure 22 (e.g., NVRAM/SPD of the DIMM or in the NVRAM/flash in the system).

Embodiments therefore begin with the straightforward application of the new risky CE indicator in online UE prediction. When the risky CE indicator is activated on a DIMM, the DIMM is predicted to experience future UEs.

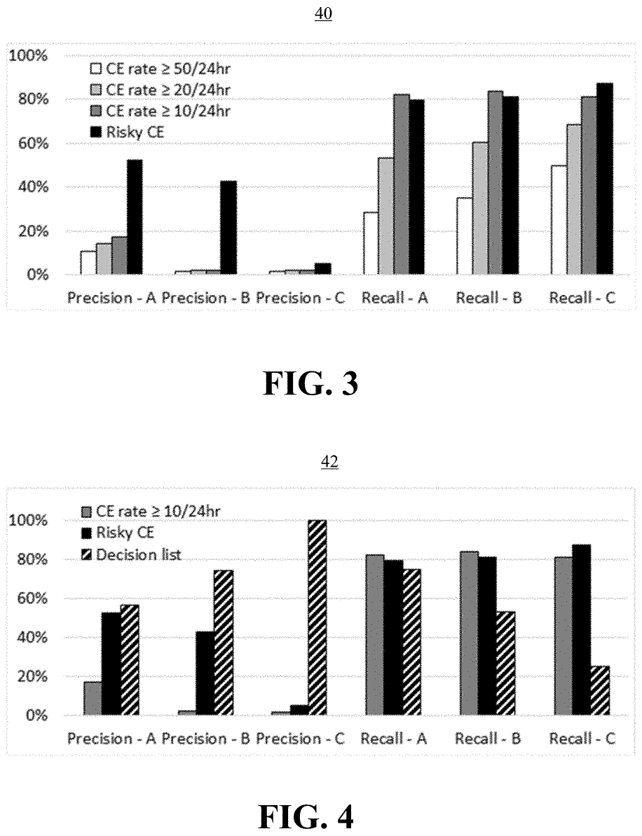

FIG. 3 shows a chart 40 of the precision (e.g., the number of positive class predictions that actually belong to the class) and recall (e.g., the number of positive class predictions made out of all positive examples in the dataset) in UE prediction by directly employing the new risky CE indicator for DIMMs from three manufacturers (e.g., SAMSUNG, HYNIX, and MICRON). For comparison, the most commonly used predictor, the CE rate predictor, is taken as the baseline. While the traditional CE rate predictor can achieve a comparable recall with a low threshold (e.g., ten CEs in the past 24 hours), the precision is significantly lower than that provided by the enhanced risky CE predictor described herein. Note that even for DIMMs from manufacturer C, though the precision of the risky CE predictor relatively quite low (5.3%), the precision is still much higher than those of the baselines (<2%).

To improve the precision values for some of the DIMM manufacturers, the enhanced risky CE indicator may be combined with DIMM part number information (e.g., taking into account two factors to build a more comprehensive UE predictor). More particularly, embodiments propose to learn a precision-driven decision list to predict future UEs based on the past CE history for a given DIMM. A decision list is an ordered set of rules for classification, wherein the left-hand side of a rule specifies the precondition and the right-hand side of the rule gives the classification result. For a given sample, rules are processed in order. Once a rule is applicable with the corresponding precondition matched, the sample is classified. Adapting decision lists to online UE prediction, embodiments combine the enhanced risky CE indicator, the DIMM part number information as an option, and the micro-level DRAM fault indicator as an option in the precondition of a rule.

FIG. 4 shows a chart 42 for evaluating a machine learning method in which the training data and test data are made exclusive. A 10-fold cross-validation is performed to maintain the exclusiveness but at the same time all the data in prediction is used so that the result is comparable with the results in the chart 40 (FIG. 3). The chart 42 shows the precision and recall by the decision list approach in online UE prediction. In the illustrated example, precision is improved in UE prediction for DIMMs from the three manufacturers by combining the risky CE indicator, micro-level fault indicators, and DIMM part number information. The improvement is particularly significant for DIMMs from manufacturer B and C. The recall becomes considerably lower as the trade-off to achieve the higher precision. Thus, using the enhanced risky CE indicator to predict future UEs outperforms the traditional approaches and achieves the state-of-the-art performance.

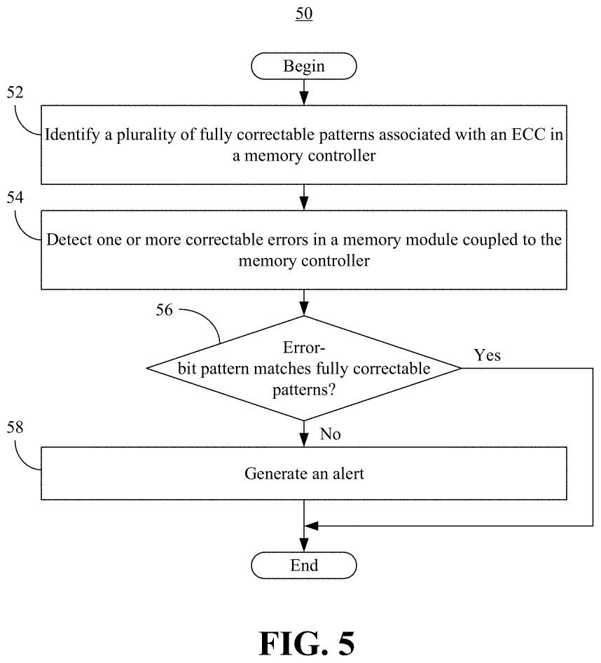

FIG. 5 shows a method 50 of operating a performance-enhanced memory controller. The method 50 may generally be implemented in a memory controller such as, for example, the memory controller 24 (FIG. 2), already discussed. More particularly, the method 50 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 50 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 52 provides for identifying a plurality of fully correctable patterns associated with an ECC in a memory controller. In one example, one or more bits of the ECC are reallocated to non-error detection operations (e.g., the ECC is weakened). Block 54 detects one or more correctable errors in a memory module (e.g., DIMM) coupled to the memory controller. Illustrated block 56 determines whether an error-bit pattern of the correctable error(s) matches any of the plurality of fully correctable patterns. In an embodiment, the error-bit pattern is a cumulative error-bit pattern (e.g., aggregated over time). If the error-bit pattern does not match any of the plurality of fully correctable patterns, block 58 generates an alert that predicts a future uncorrectable error. Block 58 may include, for example, an activation of a telemetry indicator, a storage of the alert to an SPD table in the memory module, a storage of the alert to a system non-volatile memory, etc., or any combination thereof. If it is determined at block 56 that the error-bit pattern matches one or more of the fully correctable patterns, the method 50 may bypass block 58 and terminate.

In an embodiment, block 56 also identifies micro-level fault data and/or a part number associated with the memory module. In such a case, block 58 may generate the alert further based on the micro-level fault data and/or the part number associated with the memory module (e.g., in a decision list implementation). The method 50 therefore enhances performance at least to the extent that predicting uncorrectable errors based on fully correctable patterns and actual error-bit patterns improves precision and/or recall of the predictions.

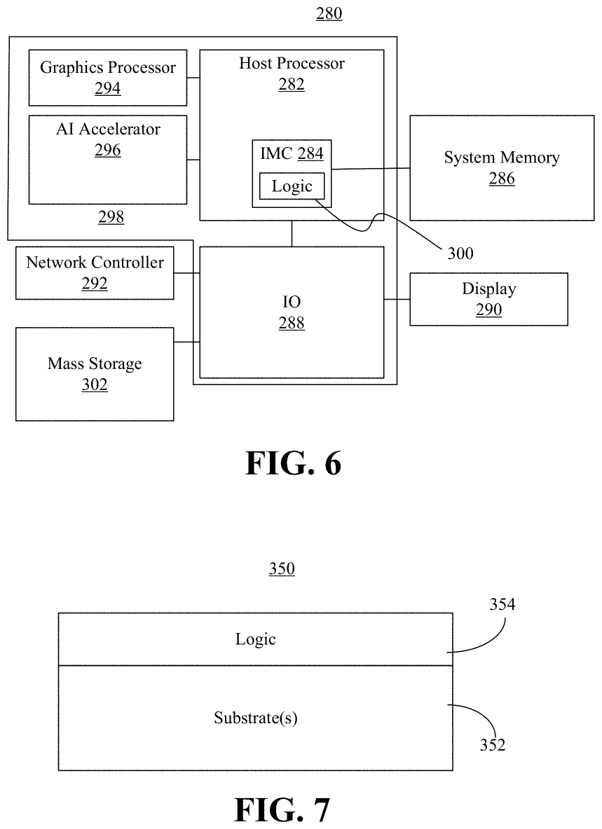

Turning now to FIG. 6, a computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., including one or more DIMMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 into a system on chip (SoC) 298.

In an embodiment, the IMC 284 includes logic 300 (e.g., logic instructions, configurable logic, fixed-functionality hardware logic, etc., or any combination thereof) to perform one or more aspects of the method 50 (FIG. 5), already discussed. Thus, the logic 300 may identify a plurality of fully correctable patterns associated with an ECC in the IMC 284, detect one or more correctable errors in the system memory 286, and generate an alert if an error-bit pattern of the one or more correctable errors does not match one or more of the plurality of fully correctable patterns. The IMC 284 is therefore considered performance-enhanced at least to the extent that predicting uncorrectable errors based on fully correctable patterns and actual error-bit patterns improves precision and/or recall of the predictions.

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 50 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

### ADDITIONAL NOTES AND EXAMPLES

Example 1 includes a performance-enhanced memory controller comprising one or more substrates and logic coupled to the one or more substrates, wherein the logic is implemented at least partly in one or more of configurable or fixed-functionality hardware, the logic to identify a plurality of fully correctable patterns associated with an error correction code (ECC) in the memory controller, detect one or more correctable errors in a memory module coupled to the memory controller, and generate an alert if an error-bit pattern of the one or more correctable errors does not match one or more of the plurality of fully correctable patterns.

Example 2 includes the memory controller of Example 1, wherein one or more bits of the ECC are reallocated to non-error detection operations.

Example 3 includes the memory controller of Example 1, wherein the error-bit pattern is a cumulative error-bit pattern.

Example 4 includes the memory controller of Example 1, wherein the alert predicts a future uncorrectable error.

Example 5 includes the memory controller of Example 1, wherein the alert is generated further based on micro-level fault data.

Example 6 includes the memory controller of any one of Examples 1 to 5, wherein the alert is generated further based on a part number associated with the memory module.

Example 7 includes the memory controller of any one of Examples 1 to 6, wherein generation of the alert includes one or more of an activation of a telemetry indicator, a storage of the alert to a serial presence detect (SPD) table in the memory module, or a storage of the alert to a system non-volatile memory.

Example 8 includes a computing system comprising a memory module, and a memory controller coupled to the memory module, wherein the memory controller includes logic coupled to one or more substrates, the logic to identify a plurality of fully correctable patterns associated with an error correction code (ECC) in the memory controller, detect one or more correctable errors in the memory module, and generate an alert if an error-bit pattern of the one or more correctable errors does not match any of the plurality of fully correctable patterns.

Example 9 includes the computing system of Example 8, wherein one or more bits of the ECC are reallocated to non-error detection operations.

Example 10 includes the computing system of Example 8, wherein the error-bit pattern is a cumulative error-bit pattern.

Example 11 includes the computing system of Example 8, wherein the alert predicts a future uncorrectable error.

Example 12 includes the computing system of any one of Examples 8 to 11, wherein the alert is generated further based on one or more of micro-level fault data or a part number associated with the memory module.

Example 13 includes the computing system of any one of Examples 8 to 12, wherein generation of the alert includes one or more of an activation of a telemetry indicator, a storage of the alert to a serial presence detect (SPD) table in the memory module, or a storage of the alert to a system non-volatile memory.

Example 14 includes at least one computer readable storage medium comprising a set of executable program instructions, which when executed by a memory controller, cause the memory controller to identify a plurality of fully correctable patterns associated with an error correction code (ECC) in the memory controller, detect one or more correctable errors in a memory module coupled to the memory controller, and generate an alert if an error-bit pattern of the one or more correctable errors does not match one or more of the plurality of fully correctable patterns.

Example 15 includes the at least one computer readable storage medium of Example 14, wherein one or more bits of the ECC are reallocated to non-error detection operations.

Example 16 includes the at least one computer readable storage medium of Example 14, wherein the error-bit pattern is a cumulative error-bit pattern.

Example 17 includes the at least one computer readable storage medium of Example 14, wherein the alert predicts a future uncorrectable error.

Example 18 includes the at least one computer readable storage medium of Example 14, wherein the alert is generated further based on micro-level fault data.

Example 19 includes the at least one computer readable storage medium of any one of Examples 14 to 18, wherein the alert is generated further based on a part number associated with the memory module.

Example 20 includes the at least one computer readable storage medium of any one of Examples 14 to 19, wherein generation of the alert includes one or more of an activation of a telemetry indicator, a storage of the alert to a serial presence detect (SPD) table in the memory module, or a storage of the alert to a system non-volatile memory.

Example 21 includes a method of operating a memory controller, the method comprising identifying a plurality of fully correctable patterns associated with an error correction code (ECC) in the memory controller, detecting one or more correctable errors in a memory module coupled to the memory controller, and generating an alert if an error-bit pattern of the one or more correctable errors does not match any of the plurality of fully correctable patterns.

Example 22 includes an apparatus comprising means for performing the method of Example 21.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A memory controller comprising:
one or more substrates; and
logic coupled to the one or more substrates, wherein the logic is implemented at least partly in one or more of configurable or fixed-functionality hardware, the logic to:
identify a plurality of fully correctable patterns associated with an error correction code (ECC) in the memory controller;
detect one or more correctable errors in a memory module coupled to the memory controller; and
generate an alert if an error-bit pattern of the one or more correctable errors does not match any of the plurality of fully correctable patterns.

2. The memory controller of claim 1, wherein one or more bits of the ECC are reallocated to non-error detection operations.

3. The memory controller of claim 1, wherein the error-bit pattern is a cumulative error-bit pattern.

4. The memory controller of claim 1, wherein the alert predicts a future uncorrectable error.

5. The memory controller of claim 1, wherein the alert is generated further based on micro-level fault data.

6. The memory controller of claim 1, wherein the alert is generated further based on a part number associated with the memory module.

7. The memory controller of claim 1, wherein generation of the alert includes one or more of an activation of a telemetry indicator, a storage of the alert to a serial presence detect (SPD) table in the memory module, or a storage of the alert to a system non-volatile memory.

8. A computing system comprising:
a memory module; and
a memory controller coupled to the memory module, wherein the memory controller includes logic coupled to one or more substrates, the logic to:
identify a plurality of fully correctable patterns associated with an error correction code (ECC) in the memory controller,
detect one or more correctable errors in the memory module, and
generate an alert if an error-bit pattern of the one or more correctable errors does not match any of the plurality of fully correctable patterns.

9. The computing system of claim 8, wherein one or more bits of the ECC are reallocated to non-error detection operations.

10. The computing system of claim 8, wherein the error-bit pattern is a cumulative error-bit pattern.

11. The computing system of claim 8, wherein the alert predicts a future uncorrectable error.

12. The computing system of claim 8, wherein the alert is generated further based on one or more of micro-level fault data or a part number associated with the memory module.

13. The computing system of claim 8, wherein generation of the alert includes one or more of an activation of a telemetry indicator, a storage of the alert to a serial presence detect (SPD) table in the memory module, or a storage of the alert to a system non-volatile memory.

14. At least one computer readable storage medium comprising a set of executable program instructions, which when executed by a memory controller, cause the memory controller to:
identify a plurality of fully correctable patterns associated with an error correction code (ECC) in the memory controller;
detect one or more correctable errors in a memory module coupled to the memory controller; and
generate an alert if an error-bit pattern of the one or more correctable errors does not match one or more of the plurality of fully correctable patterns.

15. The at least one computer readable storage medium of claim 14, wherein one or more bits of the ECC are reallocated to non-error detection operations.

16. The at least one computer readable storage medium of claim 14, wherein the error-bit pattern is a cumulative error-bit pattern.

17. The at least one computer readable storage medium of claim 14, wherein the alert predicts a future uncorrectable error.

18. The at least one computer readable storage medium of claim 14, wherein the alert is generated further based on micro-level fault data.

19. The at least one computer readable storage medium of claim 14, wherein the alert is generated further based on a part number associated with the memory module.

20. The at least one computer readable storage medium of claim 14, wherein generation of the alert includes one or more of an activation of a telemetry indicator, a storage of the alert to a serial presence detect (SPD) table in the memory module, or a storage of the alert to a system non-volatile memory.
